(19) United States
(12) Patent Application Publication
(10) Pub. No.: US 2025/0276692 A1
(43) Pub. Date: Sep. 4, 2025

(54) COMPUTER SYSTEM AND METHOD FOR CREEP MODE CONTROL

(71) Applicant: VOLVO TRUCK CORPORATION, Göteborg (SE)

(72) Inventors: Mattias ANDREASSON, Göteborg (SE); Hans BERNLER, Mölndal (SE); Yones KHATEEB, Västra Frölunda (SE)

(73) Assignee: VOLVO TRUCK CORPORATION, Göteborg (SE)

(21) Appl. No.: 19/053,853

(22) Filed: Feb. 14, 2025

(30) Foreign Application Priority Data
Mar. 4, 2024 (EP) 24161150.8

(51) Int. Cl. B60W 30/18

(52) U.S. Cl. CPC B60W 30/18063; B60W 2520/06; B60W 2520/105; B60W 2540/10; B60W 2540/12; B60W 2720/10

(57) ABSTRACT

A computer system is provided. The computer system comprises processing circuitry to detect at least a partial release of at least one of an accelerator pedal or a brake pedal of a vehicle; determine that an initial travelling speed is within a predetermined creep activation threshold; determine the brake pedal is not depressed and the accelerator pedal is not sufficiently depressed to accelerate the vehicle beyond the initial travelling speed; set an initial creep speed based on the initial travelling speed of the vehicle; and maintain the vehicle at the initial creep speed.

### TECHNICAL FIELD

The disclosure relates generally to vehicles. In particular aspects, the disclosure relates to a computer system and method for creep mode control. The disclosure can be applied to heavy-duty vehicles, such as trucks, buses, and construction equipment, among other vehicle types. Although the disclosure may be described with respect to a particular vehicle, the disclosure is not restricted to any particular vehicle.

### BACKGROUND

Vehicles may be provided with a creep mode feature. When a vehicle enters creep mode, a fixed amount of torque is typically applied in order to propel the vehicle at a slow speed. As a result, the vehicle may operate significantly different based on a number of parameters such as road inclination, road condition, and vehicle weight. Existing creep mode features thus rarely provide driving characteristics matching the driver's preference.

### SUMMARY

According to a first aspect of the disclosure, a computer system is provided. The computer system comprises processing circuitry configured to detect at least a partial release of at least one of an accelerator pedal or a brake pedal of a vehicle, determine that an initial travelling speed is within a predetermined creep activation threshold, determine that the brake pedal is not depressed and that the accelerator pedal is not sufficiently depressed to accelerate the vehicle beyond the initial travelling speed of the vehicle, set an initial creep speed based on the initial travelling speed of the vehicle, and maintain the vehicle at the initial creep speed. The first aspect of the disclosure may seek to simplify vehicle control. A technical benefit may include reducing strain of an operator of the vehicle In particular, the driver may control the creep mode speed of the vehicle based on the initial travelling speed, which requires less actuation of the accelerator pedal and/or the brake pedal.

Within the context of this specification, the term “creep” is to be interpreted as the vehicle moving in forward or reverse at a specific speed, not necessarily including the acceleration up to (or deceleration down to) the specific speed. Generally, during creep mode the specific speed of the vehicle is low such as in the range of 0 to 15 km/h, as will be further exemplified below.

Optionally in some examples, including in at least one preferred example, the processing circuitry is further configured to detect a release of at least one of the accelerator pedal or the brake pedal by at least 95%. A technical benefit may include further simplifying vehicle control; as some action on the pedals will be allowed without affecting the creep control, the driver will not be required to completely remove the pressure from the pedals.

Optionally in some examples, including in at least one preferred example, the processing circuitry is further configured to assign the initial creep speed as the initial travelling speed of the vehicle. A technical benefit may include a very responsive action of the creep activation, as the driver sets the speed as the travelling speed.

Optionally in some examples, including in at least one preferred example, the processing circuitry is further configured to obtain speed change data corresponding to a current acceleration or deceleration of the vehicle; determine that the current acceleration or deceleration is above a preset acceleration or deceleration threshold; obtain a speed adjustment factor based on the speed change data; and assign the initial creep speed as the initial travelling speed plus or minus the speed adjustment factor. A technical benefit may include a more intelligent and smooth control of the creep, by allowing the adjustment factor to compensate for the rapid speed change and thereby avoiding speed over- or undershoot.

Optionally in some examples, including in at least one preferred example, the processing circuitry is further configured to obtain creep speed increase data corresponding to the accelerator pedal of the vehicle being temporarily depressed; assign an updated creep speed based on the creep speed increase data; and maintain the vehicle at the assigned updated creep speed. A technical benefit may include simplified control and updating of the creep speed.

Optionally in some examples, including in at least one preferred example, the processing circuitry is further configured to obtain the creep speed increase data based on the depression amount of the accelerator pedal. A technical benefit may include simplified control and update of the creep speed, as the creep speed increase will be responsive to the depression amount.

Optionally in some examples, including in at least one preferred example, the processing circuitry is further configured to assign the updated creep speed as the current speed of the vehicle immediately after the accelerator pedal being temporarily depressed. A technical benefit may include fast response when updating the creep speed.

Optionally in some examples, including in at least one preferred example, the processing circuitry is further configured to assign the updated creep speed as the previous creep speed plus a preset speed increase. A technical benefit may include simplified update of the creep speed, using preset and incremental speed increase steps.

Optionally in some examples, including in at least one preferred example, the processing circuitry is further configured to obtain creep speed decrease data corresponding to the brake pedal of the vehicle being temporarily depressed; assign an updated creep speed based on the creep speed decrease data; and maintain the vehicle at the assigned updated creep speed. A technical benefit may include simplified control and updating of the creep speed.

Optionally in some examples, including in at least one preferred example, the processing circuitry is further configured to obtain the creep speed decrease data based on the depression amount of the brake pedal. A technical benefit may include simplified control and update of the creep speed, as the creep speed increase will be responsive to the depression amount.

Optionally in some examples, including in at least one preferred example, the processing circuitry is further configured to assign the updated creep speed as the current speed of the vehicle immediately after the brake pedal being temporarily depressed. A technical benefit may include fast response when updating the creep speed.

Optionally in some examples, including in at least one preferred example, the processing circuitry is further configured to assign the updated creep speed as the previous creep mode speed minus a preset speed decrease. A technical benefit may include simplified update of the creep speed, using preset and incremental speed decrease steps.

Optionally in some examples, including in at least one preferred example, the processing circuitry is further configured to: obtain vehicle motion data corresponding to the vehicle moving forward or reverse; and selecting the creep activation threshold based on the vehicle motion data. A technical benefit may include a more versatile and safe operation of the vehicle, e.g. by allowing creep only at lower speeds when operating the vehicle in reverse.

Optionally in some examples, including in at least one preferred example, the processing circuitry is further configured to obtain proximity data corresponding to the presence of a moving object ahead of the vehicle in the driving direction; assign an updated creep speed for maintaining a minimum distance to the moving object; and maintain the vehicle at the assigned updated creep speed. A technical benefit may include a more safe operation of the vehicle in creep mode.

Optionally in some examples, including in at least one preferred example, the processing circuitry is further configured to detect a release of at least one of the accelerator pedal or the brake pedal by at least 95%; assign the initial creep speed as the initial travelling speed of the vehicle; obtain creep speed increase data corresponding to the accelerator pedal of the vehicle being temporarily depressed and based on the depression amount of the accelerator pedal; assign an updated creep speed as the current speed of the vehicle immediately after the accelerator pedal has been temporarily depressed; and maintain the vehicle at the assigned updated creep speed; obtain creep speed decrease data corresponding to the brake pedal of the vehicle being temporarily depressed and based on the depression amount of the brake pedal; assign an updated creep speed based as the previous creep speed minus a preset speed decrease; and maintain the vehicle at the assigned updated creep mode speed; obtain vehicle motion data corresponding to the vehicle moving forward or reverse; and selecting the creep activation threshold based on the vehicle motion data; obtain proximity data corresponding to the presence of a moving object ahead of the vehicle in the driving direction; assign an updated creep speed for maintaining a minimum distance to the moving object; and maintain the vehicle at the assigned updated creep speed; and obtaining creep mode termination data; and terminating control of the vehicle at the updated creep speed. A technical benefit may include efficient cancelling of the creep mode of the vehicle.

According to a second aspect of the disclosure, a vehicle is provided. The vehicle comprises the computer system of the first aspect. The second aspect of the disclosure may seek to simplify vehicle control. A technical benefit may include reducing strain of an operator of the vehicle In particular, the driver may control the creep mode speed of the vehicle based on the initial travelling speed, which requires less actuation of the accelerator pedal and/or the brake pedal.

According to a third aspect of the disclosure, a computer-implemented method is provided. The computer-implemented method comprises detecting, by processing circuitry of a computer system, at least a partial release of at least one of an accelerator pedal or a brake pedal of a vehicle; determining, by the processing circuitry, that an initial travelling speed is within a predetermined creep activation threshold; determining, by the processing circuitry, the brake pedal is not depressed and the accelerator pedal is not sufficiently depressed to accelerate the vehicle beyond the initial travelling speed; setting, by the processing circuitry, an initial creep speed based on the initial travelling speed of the vehicle; and maintaining, by the processing circuitry, the vehicle at the initial creep speed. The third aspect of the disclosure may seek to simplify vehicle control. A technical benefit may include reducing strain of an operator of the vehicle In particular, the driver may control the creep mode speed of the vehicle based on the initial travelling speed, which requires less actuation of the accelerator pedal and/or the brake pedal.

Optionally in some examples, including in at least one preferred example, the method further comprises obtaining, by the processing circuitry, vehicle motion data corresponding to the vehicle moving forward or in reverse; and selecting, by the processing circuitry, the creep activation threshold based on the vehicle motion data. A technical benefit may include a more versatile and safe operation of the vehicle, e.g. by allowing creep only at lower speeds when operating the vehicle in reverse.

According to a fourth aspect of the disclosure, a computer program product is provided. The computer program product comprises program code for performing, when executed by the processing circuitry, the method of the third aspect. The fourth aspect of the disclosure may seek to simplify vehicle control. A technical benefit may include reducing strain of an operator of the vehicle In particular, the driver may control the creep mode speed of the vehicle based on the initial travelling speed, which requires less actuation of the accelerator pedal and/or the brake pedal.

According to a fifth aspect of the disclosure, a non-transitory computer-readable storage medium is provided. The non-transitory computer-readable storage medium comprises instructions, which when executed by the processing circuitry, cause the processing circuitry to perform the method of the third aspect. The fifth aspect of the disclosure may seek to simplify vehicle control. A technical benefit may include reducing strain of an operator of the vehicle In particular, the driver may control the creep mode speed of the vehicle based on the initial travelling speed, which requires less actuation of the accelerator pedal and/or the brake pedal.

The disclosed aspects, examples (including any preferred examples), and/or accompanying claims may be suitably combined with each other as would be apparent to anyone of ordinary skill in the art. Additional features and advantages are disclosed in the following description, claims, and drawings, and in part will be readily apparent therefrom to those skilled in the art or recognized by practicing the disclosure as described herein.

There are also disclosed herein computer systems, control units, code modules, computer-implemented methods, computer readable media, and computer program products associated with the above discussed technical benefits.

### BRIEF DESCRIPTION OF THE DRAWINGS

FIG. 1 is an exemplary side view of a vehicle according to an example.

FIG. 2A is an exemplary diagram of a creep control system according to an example.

FIG. 2B is an exemplary diagram of a creep speed update control system according to an example.

FIG. 3 is an exemplary diagram of a creep control system according to an example.

FIGS. 4A-C are speed diagrams illustrating creep speed set points according to different examples.

FIG. 5 is a flow chart of an exemplary method to control creep of a vehicle according to an example.

FIG. 6 is a schematic diagram of an exemplary computer system for implementing examples disclosed herein, according to an example.

### DETAILED DESCRIPTION

The detailed description set forth below provides information and examples of the disclosed technology with sufficient detail to enable those skilled in the art to practice the disclosure.

The examples presented herein provide a solution to controlling creep of a vehicle. When the vehicle is running within a preset speed interval, or at least below a preset upper speed limit, the vehicle will automatically maintain the current speed of the vehicle when the pedals are released by the driver. The driver is thereby allowed to initiate creep by releasing the pedals, and simultaneously set the creep speed by selecting the vehicle speed at which the pedals are released. The driver may thus control a creep speed of the vehicle which allows for a less straining working environment (i.e. less actuation of accelerator and brake) and simplified control of the vehicle.

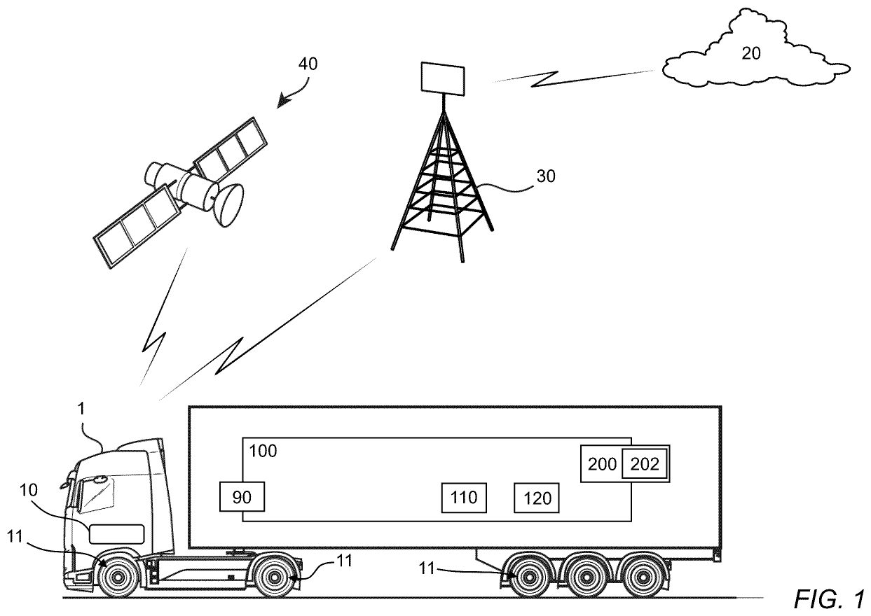

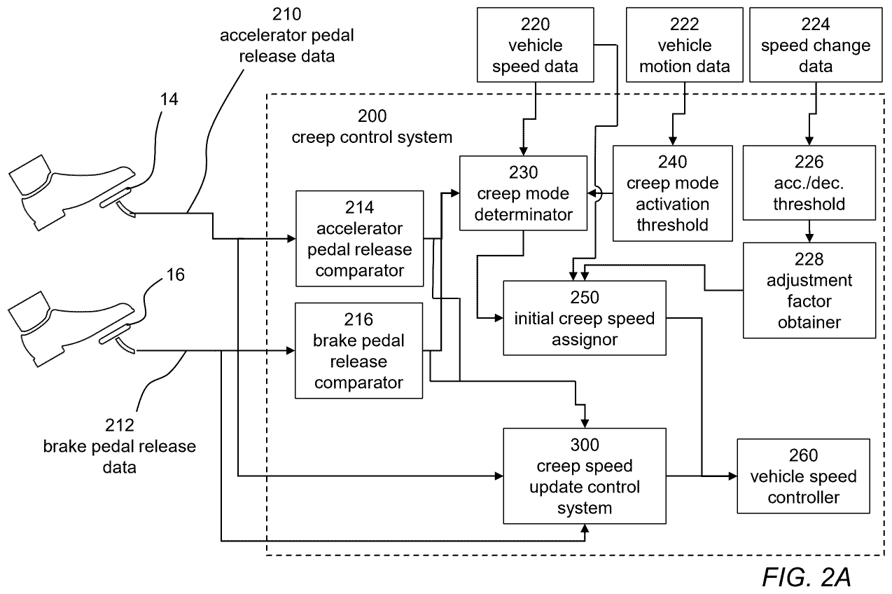

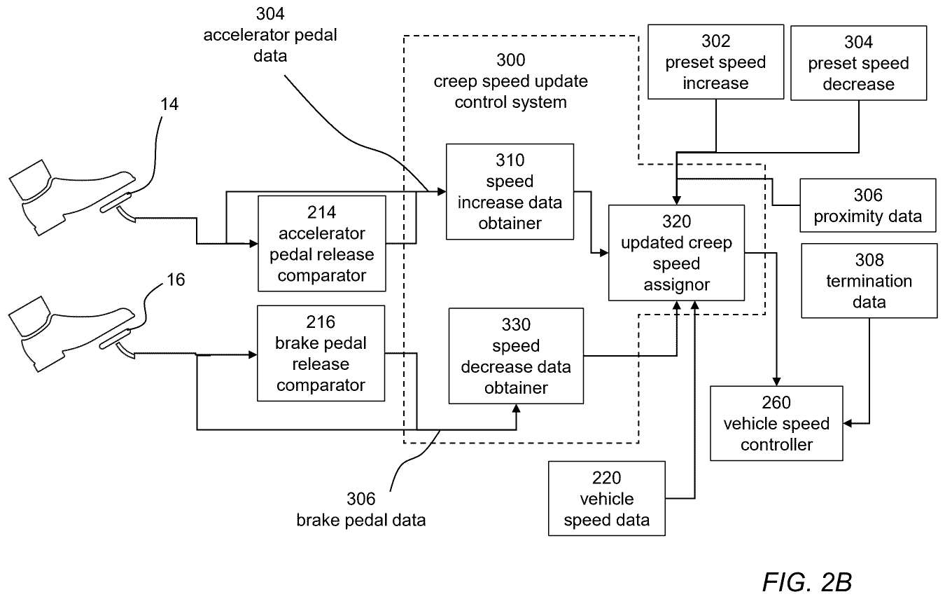

FIG. 1 is an exemplary view of a vehicle 1 according to one example. The vehicle 1 comprises one or more propulsion units 10, as well as one or more brake units 11. The one or more propulsion units 10 is configured to accelerate the vehicle 1, while the one or more brake units 11 is configured to decelerate the vehicle 1. Pedals 14, 16 (see e.g. FIG. 2) are also forming part of the vehicle 1 and used by the driver to control operation of the one or more propulsion units 10 and the one or more brake units 11. The vehicle 1 is programmed to control creep mode, or creeping, as will be described further in the following.

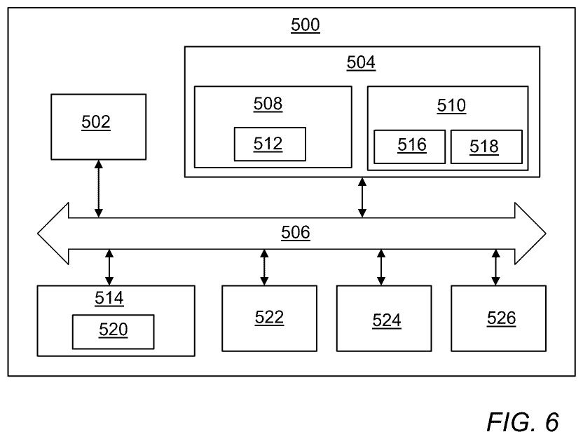

The vehicle 1 comprises, at least to some extent, processing circuitry 110 forming part of a computer system 100 (see FIG. 6). The processing circuitry 110 is configured to implement a creep control system 200. The pedals 14, 16 form part of, or is in communication with, the creep control system 200.

The vehicle 1 may further comprise communications circuitry 90 configured to receive and/or send communications. The communications circuitry 90 may be configured to enable the vehicle 1 to communicate with one or more external devices or systems such as a cloud server 20. The communication with the external devices or systems may be directly or via a communications interface such as a cellular communications interface 30, such as a radio base station. The cloud server 20 may be any suitable cloud server exemplified by, but not limited to, Amazon Web Services (AWS), Microsoft Azure, Google Cloud Platform (GCP), IBM Cloud, Oracle Cloud Infrastructure (OCI), DigitalOcean, Vultr, Linode, Alibaba Cloud, Rackspace etc. The communications interface may be a wireless communications interface exemplified by, but not limited to, Wi-Fi, Bluetooth, Zigbee, Z-Wave, LoRa, Sigfox, 2G (GSM, CDMA), 3G (UMTS, CDMA2000), 4G (LTE), 5G (NR) etc. The communication circuitry 90 may, additionally or alternatively, be configured to enable the vehicle 1 to be operatively connected to a Global Navigation Satellite System (GNSS) 40 exemplified by, but not limited to, global positioning system (GPS), Globalnaya Navigatsionnaya Sputnikovaya Sistema (GLONASS), Galileo, BeiDou Navigation Satellite System, Navigation with Indian Constellation (NavIC) etc. The vehicle 1 may for example be configured to utilize data obtain from the GNSS 40 to determine a geographical location of the vehicle 1.

The vehicle 1 in FIG. 1 comprises the computer system 100 and the creep control system 200. The computer system 100 may be operatively connected to the creep control system 200 and optionally to the communications circuitry 90 of the vehicle 1. The computer system 100 comprises processing circuitry 110. The computer system 100 may comprise a storage device 120, advantageously a non-volatile storage device such as a hard disk drives (HDDs), solid-state drives (SSDs) etc. In some examples, the storage device 120 is operatively connected to the computer system 100. The control system 200 may comprise creep control system processing circuitry 202; the creep control system processing circuitry 202 may be part of the processing circuitry 110 of the computer system 100.

FIG. 2A is a schematic diagram of a creep control system 200. The creep control system 200 is in communication with an accelerator pedal 14 of the vehicle 1 as well as with a brake pedal 16 of the vehicle 1. The pedals 14, 16 may or may not form part of the creep control system 200. The accelerator pedal 14 is configured to transmit accelerator pedal release data 210, and the brake pedal 16 is configured to transmit brake pedal release data 212. The pedal release data 210, 212 may be transmitted upon release of any of the pedals 14, 16, or the pedal release data 210, 212 may be a current state variable which is accessible for the creep control system 200 upon request.

The accelerator pedal release data 210 is received by an accelerator pedal release comparator 214. The accelerator pedal release comparator 214 is configured to determine that the accelerator pedal 14 is released, at least that it is released to a sufficient extent. The accelerator pedal release comparator 214 may be configured to operate against a certain depression amount, such that a release is determined as long as the accelerator pedal 14 is not depressed more than a predetermined amount, such as 90% or such as 95%, or such as 98%. The accelerator pedal release comparator 214 may optionally be configured to operate against current driving conditions, e.g. such that a release is determined as long as the accelerator pedal 14 is not depressed sufficiently to cause a speed increase of the vehicle 1.

The brake pedal release data 212 is received by a brake pedal release comparator 216. The brake pedal release comparator 216 is configured to determine that the brake pedal 16 is released, at least that it is released to a sufficient extent. The brake pedal release comparator 216 may be configured to operate against a certain depression amount, such that a release is determined as long as the brake pedal 16 is not depressed more than a predetermined amount, such as 90% or such as 95%, or such as 98%. The brake pedal release comparator 216 may optionally be configured to operate against current driving conditions, e.g. such that a release is determined as long as the brake pedal 16 is not depressed sufficiently to cause a speed decrease of the vehicle 1.

The accelerator pedal release comparator 214 and the brake pedal release comparator 216 are in data communication with a creep mode determinator 230. The creep mode determinator 230 is configured to receive data indicative of the accelerator pedal 14 and the brake pedal 16 being released, as identified by the respective comparator 214, 216. The creep mode determinator 230 is further configured to receive vehicle speed data 220, representing the current travelling speed of the vehicle 1. The creep mode determinator 230 is further configured to receive data representing a creep mode activation threshold 240. The creep mode activation threshold 240 may be a predetermined interval, setting the boundaries for allowable creep speeds. The creep mode determinator 230 is configured to determine that the current travelling speed of the vehicle 1 is within the creep mode activation threshold 240, and to further determine that i) the brake pedal 16 is not depressed and ii) that the accelerator pedal 14 is not sufficiently depressed to accelerate the vehicle 1 beyond the current travelling speed of the vehicle 1. The creep mode determinator 230 is configured to issue a command to an initial creep speed assignor 250. The initial creep speed assignor 250 is configured to set an initial creep speed of the vehicle based on the travelling speed of the vehicle 1, as obtained from the vehicle speed data 220.

The creep control system 200 further comprises a vehicle speed controller 260. The vehicle speed controller 260 is configured to receive the initial creep speed from the initial creep speed assignor 250, and to control the vehicle 1 in a creep mode applying the initial creep speed.

The creep mode activation threshold 240 may in some examples, including the example shown in FIG. 2A, be selected based on vehicle motion data 222. The vehicle motion data 222 may e.g. indicate if the vehicle 1 is travelling forward or in reverse. The creep mode activation threshold 240 may be a first threshold when the vehicle 1 is travelling forward, and a second threshold when the vehicle 1 is travelling in reverse. For example, the creep mode activation threshold 240 may be 2-10 km/h for forward driving, and 2-8 km/h for reverse driving. This means that when going in reverse at 10 km/h, creep mode will not be activated when the pedals 14, 16 are released.

Other parameters may be used when selecting the creep activation threshold 240. For example, vehicle motion data 220 may include data representing traffic density, visual sight, as well as data representing vehicle characteristics and/or road conditions. For example, the upper limit of the creep mode activation threshold 240 may be lower if the vehicle 1 is a heavy vehicle, if the traffic is very dense, if the road is narrow or icy, and/or if the visual sight is impaired.

The initial creep speed assignor 250 may further be configured to apply an adjustment factor when assigning the initial creep speed based on the current travelling speed of the vehicle 1. As mentioned earlier the initial creep speed may equal the current travelling speed of the vehicle 1. However in some examples the adjustment factor may cause the initial creep speed assignor to assign an initial creep speed that differs from the current travelling speed of the vehicle 1. The creep control system 200 comprises an adjustment factor obtainer 228 being configured to determine the adjustment factor based on speed change data 224. The speed change data 224 represents the current acceleration or deceleration of the vehicle 1, and a speed change threshold 226 is used by the adjustment factor obtainer 228 for determining if an adjustment factor should be applied by the initial creep speed assignor 250. As an example, if the pedals 14, 16 are released at speed being within the creep mode activation threshold, but at a time where the vehicle 1 is subject to a significant acceleration, the adjustment factor may be a certain speed increase as compared to the current travelling speed in order to avoid over- or undershoot when the creep mode is activated.

The creep control system 200 further comprises a creep speed update control system 300 being configured to update the creep speed from the initial creep speed assigned by the initial creep speed assignor 250. As shown in FIG. 2A, the creep speed update control system 300 receives accelerator pedal release data 210 and/or brake pedal release data 212 and provides input to the vehicle speed controller 260 to update the creep speed.

The creep speed update control system 300 is shown in further details in FIG. 2B. The creep speed update control system 300 is configured to cause a change in the creep speed set by the initial creep speed assignor 250 of the creep control system 200. The creep speed update control system 300 comprises a speed increase data obtainer 310. The speed increase data obtainer 310 is configured to receive accelerator pedal data 304 representing a desired creep speed increase. The accelerator pedal data 304 may be communicated directly by the accelerator pedal 14 or by the accelerator pedal release comparator 214 of the creep control system 200. The accelerator pedal data 304 typically comprises information representing a depression of the accelerator pedal 14, and preferably also the amount of depression. The accelerator pedal data 304 may also, in some examples, comprise information representing a release of the accelerator pedal 14 immediately subsequent to the depression. The accelerator pedal release comparator 214 may, as has been described previously, function as a filter by checking that the action on the accelerator pedal 14 is within a certain action threshold; hence, a very light tap on the accelerator pedal 14 may be disregarded by the accelerator pedal release comparator 214.

The creep speed update control system 300 further comprises an updated creep speed assignor 320. The updated creep speed assignor 320 is configured to receive data from the speed increase data obtainer 310, and to assign an updated creep speed based on the data received from the speed increase data obtainer 310. The updated creep speed assignor 320 may be configured to apply one or more algorithms for assigning the updated creep speed.

In one example, the updated creep speed assignor 320 is configured to assign the updated creep speed as the new vehicle travelling speed caused by the action on the accelerator pedal 14. For this, the current vehicle speed is communicated to the updated creep speed assignor 320 as vehicle speed data 220. Hence, in such example the vehicle is controlled in creep mode using an initial creep speed. If the driver wants to increase the creep speed, the driver depresses the accelerator pedal 14 thereby causing the vehicle 1 to accelerate to a higher speed. When the accelerator pedal 14 is released at the desired speed, the updated creep speed assignor 320 assigns the new (updated) creep speed as the new travelling speed of the vehicle 1. In some examples, the updated creep speed assignor 320 will also do a check that the new travelling speed of the vehicle 1 is within the current creep mode activation threshold 240 as described earlier with regards to the creep control system 200. If the new travelling speed of the vehicle 1 is outside the creep mode activation threshold 240, creep will be terminated.

Termination of the creep mode may be implemented by the updated creep speed assignor 320 transmitting termination data 308 to the vehicle speed controller 260.

In some examples the updated creep speed assignor 320 is configured to assign the updated creep speed using a preset speed increase 302. In such examples the vehicle is controlled in creep mode using an initial creep speed. If the driver wants to increase the creep speed, the driver depresses the accelerator pedal 14 thereby causing the vehicle 1 to accelerate. When the accelerator pedal 14 is released, independent on the new travelling speed of the vehicle 1 the updated creep speed assignor 320 assigns the new (updated) creep speed as the previous speed of the vehicle 1 plus a preset speed increase. For example, the preset speed increase may be 1 km/h. If a further speed increase is desired, the driver may repeatedly tap/release the accelerator pedal 14 such that a double tap may cause a speed increase by 2 km/h. In some examples, the updated creep speed assignor 320 will also do a check that the new travelling speed of the vehicle 1 is within the current creep mode activation threshold 240 as described earlier with regards to the creep control system 200. If the new travelling speed of the vehicle 1 is outside the creep mode activation threshold 240, creep will be terminated.

The creep speed update control system 300 further comprises a speed decrease data obtainer 330. The speed decrease data obtainer 330 is configured to receive brake pedal data 306 representing a desired creep speed decrease. The brake pedal data 306 may be communicated directly by the brake pedal 16 or by the brake pedal release comparator 216 of the creep control system 200. The brake pedal data 306 typically comprises information representing a depression of the brake pedal 16, and preferably also the amount of depression. The brake pedal data 306 may also, in some examples, comprise information representing a release of the brake pedal 16 immediately subsequent to the depression. The brake pedal release comparator 216 may, as has been described previously, function as a filter by checking that the action on the brake pedal 16 is within a certain action threshold; hence, a very light tap on the brake pedal 16 may be disregarded by the brake pedal release comparator 216.

The updated creep speed assignor 320 is configured to receive data from the speed decrease data obtainer 330, and to assign an updated creep speed based on the data received from the speed decrease data obtainer 330. As for the speed increase, the updated creep speed assignor 320 may be configured to apply one or more algorithms for assigning the updated creep speed.

In one example, the updated creep speed assignor 320 is configured to assign the updated creep speed as the new vehicle travelling speed caused by the action on the brake pedal 16. For this, the current vehicle speed is communicated to the updated creep speed assignor 320 as vehicle speed data 220. Hence, in such example the vehicle is controlled in creep mode using an initial creep speed. If the driver wants to decrease the creep speed, the driver depresses the brake pedal 16 thereby causing the vehicle 1 to decelerate. When the brake pedal 16 is released at the desired speed, the updated creep speed assignor 320 assigns the new (updated) creep speed as the new travelling speed of the vehicle 1. In some examples, the updated creep speed assignor 320 will also do a check that the new travelling speed of the vehicle 1 is within the current creep mode activation threshold 240 as described earlier with regards to the creep control system 200. If the new travelling speed of the vehicle 1 is outside the creep mode activation threshold 240, creep will be terminated.

In some examples the updated creep speed assignor 320 is configured to assign the updated creep speed using a preset speed decrease 304. In such examples the vehicle is controlled in creep mode using an initial creep speed. If the driver wants to decrease the creep speed, the driver depresses the brake pedal 16 thereby causing the vehicle 1 to decelerate. When the brake pedal 16 is released, independent on the new travelling speed of the vehicle 1 the updated creep speed assignor 320 assigns the new (updated) creep speed as the previous speed of the vehicle 1 minus a preset speed decrease. For example, the preset speed decrease may be 0.5 km/h. If a further speed decrease is desired, the driver may repeatedly tap/release the brake pedal 16 such that a double tap may cause a speed decrease by 1 km/h. In some examples, the updated creep speed assignor 320 will also do a check that the new travelling speed of the vehicle 1 is within the current creep mode activation threshold 240 as described earlier with regards to the creep control system 200. If the new travelling speed of the vehicle 1 is outside the creep mode activation threshold 240, creep will be terminated.

In some examples, the preset speed decrease is dependent on the depression amount of the brake pedal 16. A depression of between 0% and 15% may for example result in a speed proportional speed decrease from the current speed down to 0.5 km/h. If the current speed is 10 km/h and the depression amount is 7.5%, the updated creep speed will be 5 km/h (i.e. 50% of the initial creep speed). A depression of between 15% and 18% may bring down the creep speed to 0.5 km/h, while a depression of between 18% and 22% may for example bring down the creep speed to 0.25 km/h.

The updated creep speed assignor 320 may be further configured to receive proximity data 306, and to assign an updated creep speed based on the proximity data 306. For example, the proximity data 306 may comprise information of the traffic ahead, such as indicating that a distance to the next vehicle in front is decreasing. The updated creep speed assignor 320 may in such example set a new creep speed as a lower creep speed, thereby maintaining the distance to the traffic ahead.

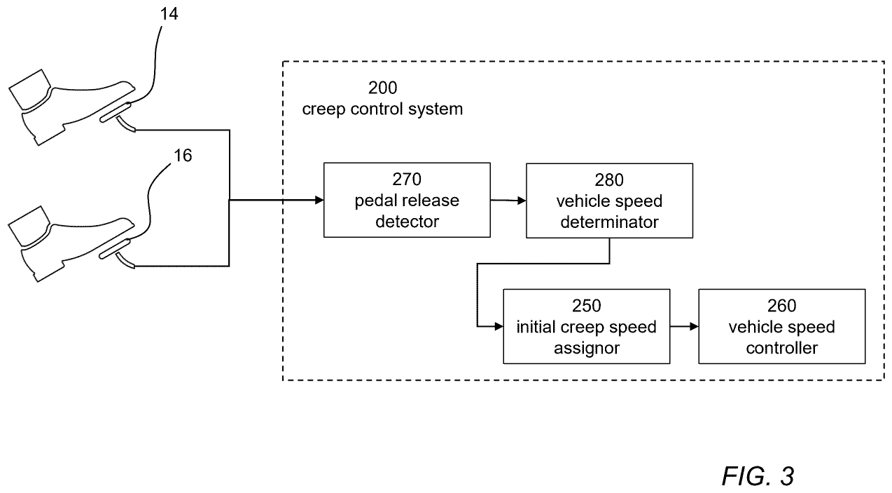

FIG. 3 shows a creep control system 200 according to an example. The creep control system 200 comprises a pedal release detector 270 configured to detect at least a partial release of at least one of an accelerator pedal 14 or a brake pedal 16 of a vehicle 1. The pedal release detector 270 may for example be implemented as the pedal release comparators 214, 216 described with reference to FIG. 2A.

The creep control system 200 further comprises a vehicle speed determinator 280 configured to determine that an initial travelling speed of the vehicle 1 is within a predetermined creep activation threshold. The vehicle speed determinator 280 may for example by implemented as the creep mode determinator 230 described with reference to FIG. 2A.

The pedal release detector 270 is further configured to determine that the brake pedal 16 is not depressed and that the accelerator pedal 14 is not sufficiently depressed to accelerate the vehicle 1 beyond the initial travelling speed.

The creep control system 200 further comprises an initial creep speed assignor 250 configured to set an initial creep speed based on the initial travelling speed of the vehicle 1, and a vehicle speed controller 260 configured to maintain the vehicle 1 at the initial creep speed.

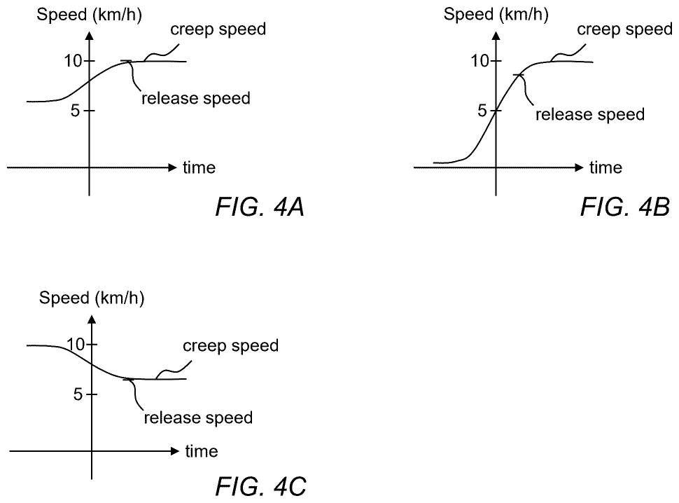

FIGS. 4A-C show diagrams illustrating the vehicle speed before and after creep is initiated by the creep control system 200. Starting in FIG. 4A, the vehicle is travelling at a speed of approximately 5 km/h. The speed is increased by a moderate acceleration up to around 10 km/h, which in this example is within the creep mode activation threshold. When the accelerator pedal is released at the final speed of 10 km/h, the creep control system 200 will control the vehicle 1 to enter creep at the same travelling speed, i.e. at 10 km/h.

In FIG. 4B another example is shown. The vehicle is initially travelling at a speed of approximately 1 km/h. The speed is increased by a heavy acceleration y pushing the accelerator pedal. At around 8 km/h, the accelerator pedal is released. As the vehicle 1 is still accelerating, the acceleration is allowed to decrease while the speed increases up to around 10 km/h, which in this example is within the creep mode activation threshold. The creep speed is assigned as the final speed of 10 km/h, corresponding to the creep control system 200 applying a speed adjustment factor as explained above, and the creep control system 200 will control the vehicle 1 to enter creep at this speed.

In FIG. 4C another example is shown. The vehicle is travelling at a speed of approximately 10 km/h. The speed is decreased by a moderate deceleration down to around 7 km/h, which in this example is within the creep mode activation threshold. When the brake pedal is released at the final speed of 7 km/h, the creep control system 200 will control the vehicle 1 to enter creep at the same travelling speed, i.e. at 7 km/h.

Other examples of initiating creep mode are possible, as will be described in the following. According to one example, the vehicle is travelling at a speed of approximately 20 km/h in an uphill slope. The creep mode activation threshold is between 3 and 10 km/h. When the accelerator pedal is released at the initial speed of 20 km/h while still travelling uphill, the vehicle will start to decelerate. The creep control system 200 will control the vehicle 1 to enter creep not at soon as the creep mode activation threshold is reached, because due to the uphill slope the maximum creep speed will likely be too fast. Instead the vehicle will be allowed to decelerate below the upper limit of the creep mode activation threshold, e.g. down to 6 km/h before creep mode is started at the specific speed of 6 km/h.

In another example the vehicle is travelling at a speed of approximately 20 km/h. The creep mode activation threshold is between 3 and 10 km/h. When the accelerator pedal is released at the initial speed of 20 km/h, the driver is immediately activate braking either by using a retarder stalk or by pressing the brake pedal. The vehicle will start to decelerate, and the creep control system 200 will control the vehicle 1 to enter creep not at soon as the creep mode activation threshold is reached, because due to the brake activation the lowest possible speed is maintained. Hence the vehicle will be allowed to decelerate down to the lower limit of the creep mode activation threshold, i.e. down to 3 km/h before creep mode is started at the specific speed of 3 km/h.

In a further example the vehicle is travelling at a speed of approximately 20 km/h. The creep mode activation threshold is between 3 and 10 km/h. The accelerator pedal is released at the initial speed of 20 km/h because the driver is approaching a vehicle travelling at 4 km/h. The vehicle will start to decelerate, and the creep control system 200 will control the vehicle 1 to enter creep not at soon as the creep mode activation threshold is reached, because due to the approaching vehicle in front the feeling of colliding should be prevented. Hence the vehicle will be allowed to decelerate down to the same speed as the vehicle in front, i.e. down to 4 km/h before creep mode is started at the specific speed of 4 km/h.

Generally, and idea is to control the vehicle 1 at a certain speed (i.e. the creep speed) based on assumed driver intentions. The driver intentions may be assessed based on actions by the driver, or by traffic characteristics. In some further examples described in the following, this will be explained.

According to one example, the vehicle is travelling in reverse at a speed of approximately 8 km/h when approaching a downhill slope. The creep mode activation threshold is between 3 and 9 km/h. When entering the downhill slope the vehicle will start to accelerate. However, the creep control system 200 will control the vehicle 1 to enter creep immediately due to a first input that the vehicle is in reverse motion, and to a second input that the vehicle is travelling downhill. Due to the downhill slope the speed of the vehicle would otherwise be allowed to increase. Instead the vehicle will be maintained at 8 km/h when creep mode is started at the specific speed of 8 km/h. Restricting the speed may be controlled by activating one or more service brakes, apply generative braking, or using an engine brake.

According to another example, the vehicle is travelling forward at a speed of approximately 20 km/h when approaching a downhill slope. The creep mode activation threshold is between 3 and 9 km/h. Before entering the downhill slope the driver presses the brake pedal to reduce the speed to e.g. 8 km/h. When entering the downhill slope at 8 km/h, the vehicle will start to accelerate. However, the creep control system 200 will control the vehicle 1 to enter creep immediately due to a first input that the vehicle is in forward motion, to a second input that the brake pedal has been pressed, and to a third input that the vehicle is travelling downhill. Due to the downhill slope and due to the braking of the driver a speed increase would otherwise increase beyond the desired speed. Instead the vehicle will be maintained at 8 km/h when creep mode is started at the specific speed of 8 km/h.

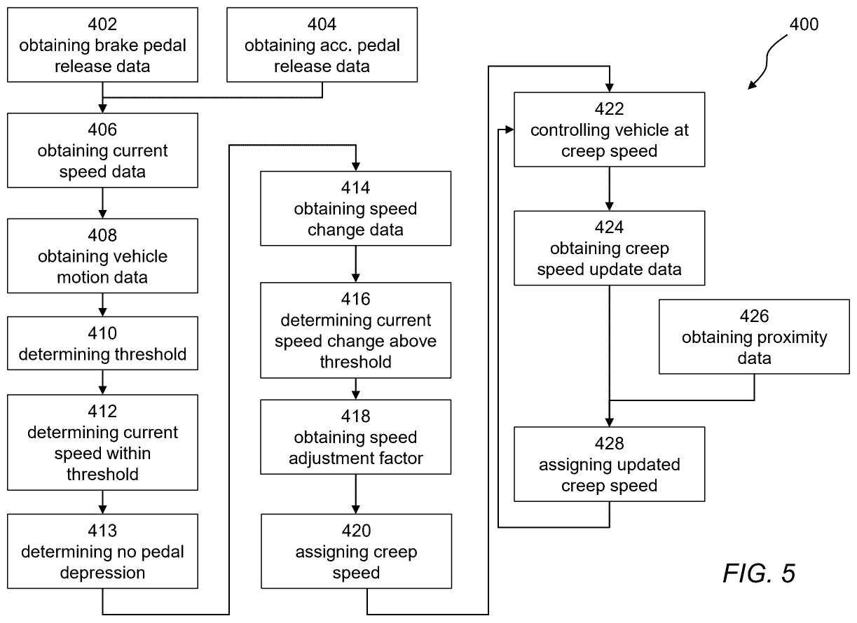

FIG. 5 is a flowchart illustrating a method 400 for controlling creep mode of a vehicle 1. The method 400 performs obtaining 402 brake pedal release data and obtaining 404 accelerator pedal release data. Hence, the method 400 detects at least a partial release of at least one of an accelerator pedal 14 or a brake pedal 16 of a vehicle 1. The method 400 further performs obtaining 406 the current travelling speed of the vehicle 1. The method 400 further performs obtaining 408 vehicle motion data, and determines 410 a creep mode activation threshold based on the vehicle motion data.

The method 400 performs determining 412 that the current travelling speed of the vehicle 1 is within the creep mode activation threshold, and further performs determining 413 that the brake pedal is not depressed and that the accelerator pedal is not sufficiently depressed to accelerate the vehicle 1 beyond the initial travelling speed.

The method 400 further performs obtaining 414 speed change data, and performs determining 416 if the current speed change (i.e. acceleration or deceleration of the vehicle 1) is within a predetermined speed change threshold. If so, the method 400 performs obtaining 418 a seed adjustment factor and the method 400 then performs assigning 420 a creep speed as well as performs controlling 422 the vehicle at the assigned creep speed.

The method 400 may also comprise obtaining 424 creep speed update data by the driver operating the accelerator pedal and/or the brake pedal. The method 400 may also comprise obtaining 428 proximity data. Based on the creep speed update data and/or the proximity data, the method 400 further performs assigning 428 an updated creep speed which is used for controlling 422 the vehicle at the updated creep speed.

FIG. 6 is a schematic diagram of a computer system 500 for implementing examples disclosed herein. The computer system 500 is adapted to execute instructions from a computer-readable medium to perform these and/or any of the functions or processing described herein. The computer system 500 may be connected (e.g., networked) to other machines in a LAN, an intranet, an extranet, or the Internet. While only a single device is illustrated, the computer system 500 may include any collection of devices that individually or jointly execute a set (or multiple sets) of instructions to perform any one or more of the methodologies discussed herein. Accordingly, any reference in the disclosure and/or claims to a computer system, computing system, computer device, computing device, control system, control unit, electronic control unit (ECU), processor device, processing circuitry, etc., includes reference to one or more such devices to individually or jointly execute a set (or multiple sets) of instructions to perform any one or more of the methodologies discussed herein. For example, control system may include a single control unit or a plurality of control units connected or otherwise communicatively coupled to each other, such that any performed function may be distributed between the control units as desired. Further, such devices may communicate with each other or other devices by various system architectures, such as directly or via a Controller Area Network (CAN) bus, etc.

The computer system 500 may comprise at least one computing device or electronic device capable of including firmware, hardware, and/or executing software instructions to implement the functionality described herein. The computer system 500 may include processing circuitry 502 (e.g., processing circuitry including one or more processor devices or control units), a memory 504, and a system bus 506. The computer system 500 may include at least one computing device having the processing circuitry 502. The system bus 506 provides an interface for system components including, but not limited to, the memory 504 and the processing circuitry 502. The processing circuitry 502 may include any number of hardware components for conducting data or signal processing or for executing computer code stored in memory 504. The processing circuitry 502 may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processing circuitry 502 may further include computer executable code that controls operation of the programmable device.

The system bus 506 may be any of several types of bus structures that may further interconnect to a memory bus (with or without a memory controller), a peripheral bus, and/or a local bus using any of a variety of bus architectures. The memory 504 may be one or more devices for storing data and/or computer code for completing or facilitating methods described herein. The memory 504 may include database components, object code components, script components, or other types of information structure for supporting the various activities herein. Any distributed or local memory device may be utilized with the systems and methods of this description. The memory 504 may be communicably connected to the processing circuitry 502 (e.g., via a circuit or any other wired, wireless, or network connection) and may include computer code for executing one or more processes described herein. The memory 504 may include non-volatile memory 508 (e.g., read-only memory (ROM), erasable programmable read-only memory (EPROM), electrically erasable programmable read-only memory (EEPROM), etc.), and volatile memory 510 (e.g., random-access memory (RAM)), or any other medium which can be used to carry or store desired program code in the form of machine-executable instructions or data structures and which can be accessed by a computer or other machine with processing circuitry 502. A basic input/output system (BIOS) 512 may be stored in the non-volatile memory 508 and can include the basic routines that help to transfer information between elements within the computer system 500.

The computer system 500 may further include or be coupled to a non-transitory computer-readable storage medium such as the storage device 514, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 514 and other drives associated with computer-readable media and computer-usable media may provide non-volatile storage of data, data structures, computer-executable instructions, and the like.

Computer-code which is hard or soft coded may be provided in the form of one or more modules. The module(s) can be implemented as software and/or hard-coded in circuitry to implement the functionality described herein in whole or in part. The modules may be stored in the storage device 514 and/or in the volatile memory 510, which may include an operating system 516 and/or one or more program modules 518. All or a portion of the examples disclosed herein may be implemented as a computer program 520 stored on a transitory or non-transitory computer-usable or computer-readable storage medium (e.g., single medium or multiple media), such as the storage device 514, which includes complex programming instructions (e.g., complex computer-readable program code) to cause the processing circuitry 502 to carry out actions described herein. Thus, the computer-readable program code of the computer program 520 can comprise software instructions for implementing the functionality of the examples described herein when executed by the processing circuitry 502. In some examples, the storage device 514 may be a computer program product (e.g., readable storage medium) storing the computer program 520 thereon, where at least a portion of a computer program 520 may be loadable (e.g., into a processor) for implementing the functionality of the examples described herein when executed by the processing circuitry 502. The processing circuitry 502 may serve as a controller or control system for the computer system 500 that is to implement the functionality described herein.

The computer system 500 may include an input device interface 522 configured to receive input and selections to be communicated to the computer system 500 when executing instructions, such as from a keyboard, mouse, touch-sensitive surface, etc. Such input devices may be connected to the processing circuitry 502 through the input device interface 522 coupled to the system bus 506 but can be connected through other interfaces, such as a parallel port, an Institute of Electrical and Electronic Engineers (IEEE) 1394 serial port, a Universal Serial Bus (USB) port, an IR interface, and the like. The computer system 500 may include an output device interface 524 configured to forward output, such as to a display, a video display unit (e.g., a liquid crystal display (LCD) or a cathode ray tube (CRT)). The computer system 500 may include a communications interface 526 suitable for communicating with a network as appropriate or desired.

The operational actions described in any of the exemplary aspects herein are described to provide examples and discussion. The actions may be performed by hardware components, may be embodied in machine-executable instructions to cause a processor to perform the actions, or may be performed by a combination of hardware and software. Although a specific order of method actions may be shown or described, the order of the actions may differ. In addition, two or more actions may be performed concurrently or with partial concurrence.

Example 1:
A computer system comprising processing circuitry configured to: detect at least a partial release of at least one of an accelerator pedal (14) or a brake pedal (16) of a vehicle (1); determine that an initial travelling speed is within a predetermined creep activation threshold (240); determine the brake pedal (16) is not depressed and the accelerator pedal (14) is not sufficiently depressed to accelerate the vehicle (1) beyond the initial travelling speed; set an initial creep speed based on the initial travelling speed of the vehicle; and maintain the vehicle (1) at the initial creep speed.

Example 2: The computer system of Example 1, wherein the processing circuitry is further configured to: detect a release of at least one of the accelerator pedal (14) or the brake pedal (16) by at least 95
%.

Example 3: The computer system of any of Examples 1-2, wherein the processing circuitry is further configured to: assign the initial creep speed as the initial travelling speed of the vehicle (1).

Example 4: The computer system of any of Examples 1-2, wherein the processing circuitry is further configured to: obtain speed change data corresponding to a current acceleration or deceleration of the vehicle (1); determine that the current acceleration or deceleration is above a preset acceleration or deceleration threshold (226); obtain a speed adjustment factor based on the speed change data; and assign the initial creep speed as the initial travelling speed plus or minus the speed adjustment factor.

Example 5: The computer system of any of Examples 1-4, wherein the processing circuitry is further configured to: obtain creep speed increase data corresponding to the accelerator pedal (14) of the vehicle (1) being temporarily depressed; assign an updated creep speed based on the creep speed increase data; and maintain the vehicle (1) at the assigned updated creep speed.

Example 6: The computer system of Example 5, wherein the processing circuitry is further configured to: obtain the creep speed increase data based on the depression amount of the accelerator pedal (14).

Example 7: The computer system of any of Examples 5-6, wherein the processing circuitry is further configured to: assign the updated creep speed as the current speed of the vehicle (1) immediately after the accelerator pedal (14) being temporarily depressed.

Example 8: The computer system of any of Examples 5-6, wherein the processing circuitry is further configured to: assign the updated creep speed as the previous creep speed plus a preset speed increase.

Example 9: The computer system of any of Examples 1-8, wherein the processing circuitry is further configured to: obtain creep speed decrease data corresponding to the brake pedal (16) of the vehicle (1) being temporarily depressed; assign an updated creep speed based on the creep speed decrease data; and maintain the vehicle (1) at the assigned updated creep speed.

Example 10: The computer system of Example 9, wherein the processing circuitry is further configured to: obtain the creep speed decrease data based on the depression amount of the brake pedal (16).

Example 11: The computer system of any of Examples 9-10, wherein the processing circuitry is further configured to: assign the updated creep speed as the current speed of the vehicle (1) immediately after the brake pedal (16) being temporarily depressed.

Example 12: The computer system of any of Examples 9-10, wherein the processing circuitry is further configured to: assign the updated creep speed as the previous creep mode speed minus a preset speed decrease.

Example 13: The computer system of any of Examples 1-13, wherein the processing circuitry is further configured to: obtain vehicle motion data (222) corresponding to the vehicle (1) moving forward or reverse; and selecting the creep activation threshold (240) based on the vehicle motion data (222).

Example 14: The computer system of any of Examples 1-13, wherein the processing circuitry is further configured to: obtain proximity data (306) corresponding to the presence of a moving object ahead of the vehicle (1) in the driving direction; assign an updated creep speed for maintaining a minimum distance to the moving object; and maintain the vehicle (1) at the assigned updated creep speed.

Example 15: The computer system of Example 1, wherein the processing circuitry is further configured to: detect a release of at least one of the accelerator pedal (14) or the brake pedal (16) by at least 95%; assign the initial creep speed as the initial travelling speed of the vehicle (1); obtain creep speed increase data corresponding to the accelerator pedal (14) of the vehicle (1) being temporarily depressed and based on the depression amount of the accelerator pedal (14); assign an updated creep speed as the current speed of the vehicle (1) immediately after the accelerator pedal (14) has been temporarily depressed; and maintain the vehicle (1) at the assigned updated creep speed; obtain creep speed decrease data corresponding to the brake pedal (16) of the vehicle (1) being temporarily depressed and based on the depression amount of the brake pedal (16); assign an updated creep speed based as the previous creep speed minus a preset speed decrease; and maintain the vehicle (1) at the assigned updated creep mode speed; obtain vehicle motion data (222) corresponding to the vehicle (1) moving forward or reverse; and selecting the creep activation threshold (240) based on the vehicle motion data (222); obtain proximity data (306) corresponding to the presence of a moving object ahead of the vehicle (1) in the driving direction; assign an updated creep speed for maintaining a minimum distance to the moving object; and maintain the vehicle (1) at the assigned updated creep speed; and obtaining creep mode termination data; and terminating control of the vehicle (1) at the updated creep speed.

Example 16: A vehicle (1) comprising the computer system of any of Examples 1-15.

Example 17: A computer-implemented method, comprising: detecting (402, 404), by processing circuitry of a computer system, at least a partial release of at least one of an accelerator pedal or a brake pedal of a vehicle; determining (412), by the processing circuitry, that an initial travelling speed is within a predetermined creep activation threshold; determining (413), by the processing circuitry, the brake pedal is not depressed and the accelerator pedal is not sufficiently depressed to accelerate the vehicle beyond the initial travelling speed; setting (420), by the processing circuitry, an initial creep speed based on the initial travelling speed of the vehicle; and maintaining (422), by the processing circuitry, the vehicle at the initial creep speed.

Example 18: The method of Example 17, further comprising: obtaining (408), by the processing circuitry, vehicle motion data corresponding to the vehicle moving forward or in reverse; and selecting (410), by the processing circuitry, the creep activation threshold based on the vehicle motion data.

Example 19: A computer program product comprising program code for performing, when executed by the processing circuitry, the method of any of Examples 17-18.

Example 20: A non-transitory computer-readable storage medium comprising instructions, which when executed by the processing circuitry, cause the processing circuitry to perform the method of any of Examples 17-18.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

1. A computer system comprising processing circuitry configured to:
detect at least a partial release of at least one of an accelerator pedal or a brake pedal of a vehicle;
determine that an initial travelling speed is within a predetermined creep activation threshold;
determine the brake pedal is not depressed and the accelerator pedal is not sufficiently depressed to accelerate the vehicle beyond the initial travelling speed;
set an initial creep speed based on the initial travelling speed of the vehicle; and
maintain the vehicle at the initial creep speed.

2. The computer system of claim 1, wherein the processing circuitry is further configured to:
detect a release of at least one of the accelerator pedal or the brake pedal by at least 95%.

3. The computer system of claim 1, wherein the processing circuitry is further configured to:
assign the initial creep speed as the initial travelling speed of the vehicle.

4. The computer system of claim 1, wherein the processing circuitry is further configured to:
obtain speed change data corresponding to a current acceleration or deceleration of the vehicle;
determine that the current acceleration or deceleration is above a preset acceleration or deceleration threshold;
obtain a speed adjustment factor based on the speed change data; and
assign the initial creep speed as the initial travelling speed plus or minus the speed adjustment factor.

5. The computer system of claim 1, wherein the processing circuitry is further configured to:
obtain creep speed increase data corresponding to the accelerator pedal of the vehicle being temporarily depressed;
assign an updated creep speed based on the creep speed increase data; and
maintain the vehicle at the assigned updated creep speed.

6. The computer system of claim 5, wherein the processing circuitry is further configured to:
obtain the creep speed increase data based on the depression amount of the accelerator pedal.

7. The computer system of claim 1 wherein the processing circuitry is further configured to:
obtain creep speed decrease data corresponding to the brake pedal of the vehicle being temporarily depressed;
assign an updated creep speed based on the creep speed decrease data; and
maintain the vehicle at the assigned updated creep speed.

8. The computer system of claim 7, wherein the processing circuitry is further configured to:
obtain the creep speed decrease data based on the depression amount of the brake pedal.

9. The computer system of claim 1, wherein the processing circuitry is further configured to:
obtain vehicle motion data corresponding to the vehicle moving forward or reverse; and
selecting the creep activation threshold based on the vehicle motion data.

10. The computer system of claim 1, wherein the processing circuitry is further configured to:
detect a release of at least one of the accelerator pedal or the brake pedal by at least 95%;
assign the initial creep speed as the initial travelling speed of the vehicle;
obtain creep speed increase data corresponding to the accelerator pedal of the vehicle being temporarily depressed and based on the depression amount of the accelerator pedal;
assign an updated creep speed as the current speed of the vehicle immediately after the accelerator pedal has been temporarily depressed; and
maintain the vehicle at the assigned updated creep speed;
obtain creep speed decrease data corresponding to the brake pedal of the vehicle being temporarily depressed and based on the depression amount of the brake pedal;
assign an updated creep speed based as the previous creep speed minus a preset speed decrease; and
maintain the vehicle at the assigned updated creep mode speed;
obtain vehicle motion data corresponding to the vehicle moving forward or reverse; and
selecting the creep activation threshold based on the vehicle motion data;
obtain proximity data corresponding to the presence of a moving object ahead of the vehicle in the driving direction;
assign an updated creep speed for maintaining a minimum distance to the moving object; and
maintain the vehicle at the assigned updated creep speed; and
obtaining creep mode termination data; and
terminating control of the vehicle at the updated creep speed.

11. A vehicle comprising the computer system of claim 1.

12. A computer-implemented method, comprising:
detecting, by processing circuitry of a computer system, at least a partial release of at least one of an accelerator pedal or a brake pedal of a vehicle;
determining, by the processing circuitry, that an initial travelling speed is within a predetermined creep activation threshold;
determining, by the processing circuitry, the brake pedal is not depressed and the accelerator pedal is not sufficiently depressed to accelerate the vehicle beyond the initial travelling speed;
setting, by the processing circuitry, an initial creep speed based on the initial travelling speed of the vehicle; and
maintaining, by the processing circuitry, the vehicle at the initial creep speed.

13. The method of claim 12, further comprising:
obtaining, by the processing circuitry, vehicle motion data corresponding to the vehicle moving forward or in reverse; and
selecting, by the processing circuitry, the creep activation threshold based on the vehicle motion data.

14. A computer program product comprising program code for performing, when executed by the processing circuitry, the method of claim 12.

15. A non-transitory computer-readable storage medium comprising instructions, which when executed by the processing circuitry, cause the processing circuitry to perform the method of claim 12.
